(19) United States
(12) Patent Application Publication
(10) Pub. No.: US 2012/0094110 A1
(43) Pub. Date: Apr. 19, 2012

(54) Coatings Using Dialkyl/Dialkenyl Ethers as Hydrophobing Agents, Use Thereof and Metals Provided with the Coating

(75) Inventors: Oliver Herzog, Geesthacht (DE); Boie Witt, Brunsbuttel (DE)

(73) Assignee: Sasol Germany GMBH, Hamburg (DE)

(21) Appl. No.: 13/257,232

(22) PCT Filed: Mar. 15, 2010
(86) PCT No.: PCT/DE10/00277

§ 371 Date: Nov. 25, 2011

(30) Foreign Application Priority Data
Mar. 18, 2009 (DE) 102009013315.1

(51) Int. Cl. C09D 5/36; B05D 1/00

(52) U.S. Cl. 428/332; 427/402

(57) ABSTRACT

The invention relates to the coatings of surfaces using dialkyl/dialkenyl ethers, particularly for purposes of hydrophobizing surfaces, to metals provided with such a coating, including metal compounds or alloys, and to a method of apply coatings to surfaces.

The invention relates to coatings of surfaces using dialkyl/dialkenyl ethers, in particular for purposes of hydrophobing surfaces, to metals provided with such a coating, including metal compounds or alloys, and to the use of the coatings as surface protection.

A water-repelling effect of surfaces can be achieved if said surface is made hydrophobic and/or the surface structures are suitably modified. For example, in nature this can be seen in the leaf of the lotus, which exhibits extremely high water repulsion. This is caused by a complex micro- and nanoscopic structure of the surface. The object of many developments has been, and still is the utilisation of this property in commercial products.

According to CH 268258, silicone oils and polymers are used to permanently apply powder formed of kaoline, talc, clay or silica gel to surfaces which, once treated accordingly, are to exhibit water repulsion similar to that of a lotus leaf.

EP 0909747 A1 teaches the formation of hydrophobic surfaces by applying a dispersion of power particles formed of an inert material in a hydrophobing siloxane solution with subsequent curing, said surfaces comprising bumps measuring approximately 5 to 200 μm.

WO 00/58410 and WO 96/04123 describe self-cleaning surfaces obtainable by applying a liquid containing a hydrophobic material, wherein the hydrophobic material, in a “self-organising” manner after evaporation, forms a surface structure comprising undulations having a distance of 0.1 to 200 μm and a height of 0.1 to 100 μm. Waxes (WO 00/58410), for example long-chain alkanes, alcohols, in particular diols, and ketones, in particular diketones, or polymers (WO 96/04123) are mentioned as hydrophobic material.

Many of the substances known from the prior art having low free surface energy, such as silicones or perfluoro compounds, have an undesirable effect because they influence the further processability of the workpieces. Even with use of aggressive cleaning agents these compounds cannot be completely removed from the surfaces and therefore problems are often encountered during further processing.

The object of the present invention was to develop a method for hydrophobing surfaces, in particular for temporary hydrophobing, of which the coating can be removed by commercially available cleaning agents, and of which the further processing, such as overcoating or fusing, is unproblematic.

It has surprisingly been found that the object is achieved by the subject matter of the independent claims. Advantageous embodiments are the subject matter of the dependent claims or will be described hereinafter.

The coating of surfaces with dialkyl/dialkenyl ethers is 2-dimensional and leads to an advantageous hydrophobing of the surface which is easily removable and, moreover, may have a pearlescent effect.

Linear dialkyl/dialkenyl ethers have low surface tensions in the region of 30 mN/m and can nevertheless be easily and comprehensively removed from surfaces using commercially available cleaners. An example of this is protective lacquers, such as car polishes. Dialkyl/dialkenyl ethers are not attacked by water and can only be removed in conjunction with appropriate cleaners. Furthermore, surfaces thus treated afford the advantage of being easily wettable by many organic materials. By contrast, silicone-containing products with a hydrophobing effect cannot be removed, or cannot be removed completely. A further advantage of the dialkyl/dialkenyl ethers used in accordance with the invention is the good environmental compatibility of these materials in contrast to silicone oils or perfluoro compounds. The dialkyl/dialkenyl ethers form a film on the surface of the coated material, which film exhibits greater resistance to water owing to its microroughness compared to tested comparative products from the family of alcohols, paraffins and waxes. The hydrophobic material can be applied in the solid state, as a solution, in dispersion or in emulsion.

In accordance with one embodiment the hydrophobic material is applied as a solid, either in powder form or as a melt. The hydrophobic layer is formed when the melt is cooled. Owing to the excellent spreading properties of dialkyl ethers in liquid form, these are distributed uniformly in a thin layer over the material. The powder may be a micronized solid which is applied to the surface, or a ground stock of coarser, more heterogeneous particle size distribution.

Suitable hydrophobing dialkyl/dialkylene ethers are those of general total formula R¹—O—R², wherein R¹ and R² may be saturated or unsaturated alkyl/alkylene chains with chain lengths of 1 and more carbon atoms if the dialkyl/dialkylene ethers comprise more than 18 carbon atoms in total. Linear dialkyl ethers of equal chain length (R¹=R²) such as didodecyl ether, ditridecyl ether, ditetradecyl ether, dipentadecyl ether, dihexadecyl ether, diheptadecyl ether, dioctodecyl ether, dinonadecyl ether, dieicosyl ether, diheneicosyl ether, didocosyl ether, ditricosyl ether, ditetracosyl ether, dipentacosyl ether, dihexacosyl ether, diheptacosyl ether, dioctacosyl ether, dinonacosyl ether or ditriacontyl ether and mixtures thereof, in particular ditetradecyl ether, dihexadecyl ether, dioctadecyl ether, dieicosyl ether or didocosyl ether have proven to be particularly suitable.

In accordance with one embodiment of the invention the dialkyl/dialkylene ethers can be used together with additives which form part of the coating, such as C14 to C36 fatty alcohols, in particular linear C14 to C36 fatty alcohols, wherein 1-alkanols such as 1-tetradecanol, 1-pentadecanol, 1-hexadecanol, 1-heptadecanol, 1-octadecanol, 1-nonadecanol, 1-eicosanol, 1-heneicosanol, 1-docosanol, 1-tricosanol, 1-tetracosanol, 1-pentacosanol, 1-hexacosanol, 1-heptacosanol, 1-octacosanol, 1-nonacosanol or 1-triacontanol are preferred.

Further suitable additives which can be used either together with, or without the C14 to C32 fatty alcohols are C14 to C32 carboxylic acids, in particular fatty acids or linear mono-1 carboxylic acids such as 1-decanoic acid, 1-undecanoic acid, 1-dodecanoic acid, 1-tridecanoic acid, 1-tetradecanoic acid, 1-pentadecanoic acid, 1-hexadecanoic acid, 1-heptadecanoic acid, 1-octadecanoic acid, 1-nonadecanoic acid, 1-eicosanoic acid, 1-heneicosanoic acid, 1-docosanoic acid, 1-tricosanoic acid, 1-tetracosanoic acid, 1-pentacosanoic acid, 1-hexacosanoic acid, 1-heptacosanoic acid, 1-octacosanoic acid, 1-nonacosanoic acid and 1-tricontanoic acid.

The fraction of the above additives in the coating is preferably (together) 5 to 40 by weight, in particular 7 to 30% by weight.

For example, these additives can be used to increase the adhesion to the surface, without having a detrimental effect on the hydrophobing properties.

For example, possible fields of application of the hydrophobing agents according to the invention include, but are not limited to: articles of clothing, awnings, paints, for example car paints, building walls or leather goods.

Furthermore, 0.5 to 10% by weight of inorganic particles, in particular 0.5 to less than 5% by weight, may be incorporated in the coating, for example those having mean particle diameters D₅₀, determined in accordance with ISO 13320-1 and evaluated in accordance with the Fraunhofer theory, of less than 50 μm, in particular particulate metal oxides, misch metal oxides and/or oxide hydrates thereof, such as silicic acid, diatomaceous earth, kaoline or alumina particles.

A further field of application for temporary hydrophobic coatings is the protection of high-grade metals/metal parts against corrosion. The possibility of residue-free removal of the protective layer for subsequent further processing of the parts is important in this instance.

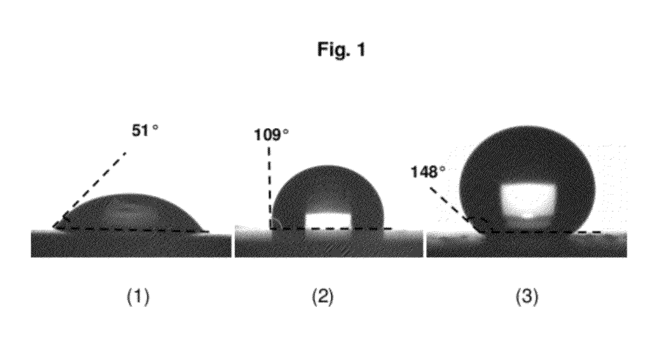

The invention will be explained by FIG. 1 and the following examples, but is not limited thereto.

The general working instructions detailed below apply to all examples given.

The following methods were used for the coating of bodies:

### a) Dipping Method

The coating agent was melted at a temperature of at least 5° C. above its melting point. The body to be coated, for example a glass slide, was dipped into this melt and quickly withdrawn again.

In this way layer thicknesses in the range of 50 μm to 500 μm were obtained, wherein the layer thickness depends, inter alia, on the temperature of the object and the speed of the withdrawal.

### b) Powder Coating

The coating agent was ground to a fine powder using a coffee mill. The powder was distributed uniformly over the surface of the object to be coated, for example a glass slide. The object was then tempered in a furnace for 10 minutes at a temperature of at least 5° C. above the melting point and was then cooled, wherein the coating was formed. In this way, layer thicknesses of 10 μm to 500 μm were obtained.

### c) Coating by Means of Solvents

20% of the coating agent was dissolved in acetone with gentle heating to 40° C. The solution was placed in a vessel provided with an atomiser and was applied to the surface of the object to be coated, for example a glass slide, in the form of an aerosol mist using the atomiser. Once the solvent had evaporated, layer thicknesses of 500 nm to 300 μm were measured, wherein the layer thickness depends, inter alia, on the number of spraying applications and on the concentration of the solution.

The contact angles were measured using a DSA100 contact angle measuring device by Krüss. For this purpose the coated surface was wetted with a drop of water. The drop was illuminated from one side and recorded on the opposite side by a camera. The film obtained was evaluated with the aid of DSA 100 software. In order to determine the contact angle (see FIG. 1), the arithmetic mean was determined from 100 measurement points, wherein 1 measurement point is the arithmetic mean of the contact angle from the left-hand and right-hand drop contour.

The evaluation only starts once the drop can be seen completely on the surface. At least one triple analysis was carried out.

FIG. 1 shows the determination of the contact angle on the basis of photographs of differently coated surfaces (1)=cetyl stearyl alcohol, (2) beeswax 8108 and (3)=dioctadecyl ether.

The layer thickness of the uncoated object (for example a glass slide) was measured by means of a layer thickness measuring device at 10 different defined positions. The measurement was repeated after the application process and the layer thickness was determined from the difference.

### EXAMPLE 1

Dioctadecyl ether, for example obtainable under the name NACOL® Ether 18 from Sasol Germany GmbH was applied from the melt to a desired surface. After cooling the ether exhibited an opalescent effect. The surface was hydrophobic owing to the coating and was thus protected against water. A contact angle of water of 148° was measured on the material thus treated.

### EXAMPLE 2

Dioctadecyl ether, for example obtainable as NACOL® Ether 18 from Sasol Germany GmbH, was ground finely and applied uniformly in the form of a powder to a desired surface. After tempering at 80° C., the contact angle of water on the surface was determined to be 148°. A pearlescent effect is observed.

### EXAMPLE 3

Dihexadecyl ether, for example obtainable as NACOL® Ether 16 from Sasol Germany GmbH, was ground finely and applied uniformly in the form of a powder to a desired surface. After tempering at 80° C., the contact angle of water on the surface was determined to be 141°.

### EXAMPLE 4

Dihexadecyl ether, for example obtainable as NACOL® Ether 16 from Sasol Germany GmbH, was applied from the melt to a desired surface.

After tempering at 80° C., the contact angle of water on the surface was determined to be 141°.

### EXAMPLE 5

Didocosyl ether was applied from the melt to a desired surface. After tempering at 80° C., the contact angle of water on the surface was determined to be 144°.

### EXAMPLE 6

Didocosyl ether was ground finely and applied uniformly in the form of a powder to a desired surface. After tempering at 80° C., the contact angle of water on the surface was determined to be 141°. A pearlescent effect was observed.

### EXAMPLE 7

Dioctadecyl ether, for example obtainable as NACOL® Ether 18 from Sasol Germany GmbH, was applied in the form of 20% solution in acetone to a desired surface. Once the solvent had evaporated, the contact angle of water on the surface was determined to be 156°.

### EXAMPLE 8

80% by weight dioctadecyl ether (NACOL® Ether 18 ex. Sasol Germany GmbH) and 20% by weight 1-octadecanol (NACOL® 18-98 ex. Sasol Germany GmbH) were melted at 80° C. and mixed thoroughly by stirring. The melt was applied to a desired surface. After cooling, the ether exhibited an opalescent effect. Directly after impact of the water drop on the surface a contact angle of water on the surface of 153° was observed on the material thus treated, and after movement/oscillation of the water drop a contact angle of 170° was observed once the water drop had come to a stop.

### EXAMPLE 9

50% by weight dioctadecyl ether (NACOL® Ether 18 ex. Sasol Germany GmbH) and 50% by weight 1-octadecanol (NACOL® 18-98 ex. Sasol Germany GmbH) were melted at 80° C. and mixed thoroughly by stirring. The melt was applied to a desired surface. After cooling, the ether exhibited an opalescent effect. A contact angle of water on the surface of 120° was measured on the material thus treated.

### COMPARATIVE EXAMPLE 1

Beeswax 8108, for example obtainable from Kahl & Co Vertriebsgesellschaft mbH, Tritau, was applied from the melt to a desired surface. After cooling, a contact angle of water on the wax layer of 109° was found.

### COMPARATIVE EXAMPLE 2

1-octadecanol, for example obtainable under the name NACOL® 18-98 from Sasol Germany GmbH, was applied from the melt to a desired surface. After cooling, a contact angle of water on the wax layer of 101° was found.

### COMPARATIVE EXAMPLE 3

1-octadecanol, for example obtainable under the name NACOL® 18-98 from Sasol Germany GmbH, was applied as 20% solution in acetone to a desired surface. Once the solvent had evaporated, a contact angle of water on the surface of 112° was measured.

### COMPARATIVE EXAMPLE 4

Octadecane, for example obtainable under the name Parafol® 18-97 from Sasol Germany GmbH, was applied from the melt to a desired surface. After cooling, a contact angle of water on the wax layer of 111° was found.

### COMPARATIVE EXAMPLE 5

Montan wax having a dripping point of 82° C. and an acid number of 144 mg KOH/g (Licowax® S ex. Clariant), was applied from the melt to a desired surface. After cooling, a contact angle of water on the wax layer of 111° was found.

### COMPARATIVE EXAMPLE 6

A narrowly distributed Fischer-Tropsch paraffin wax having a solidification point of 80° C. (Sasolwax® C80 ex. Sasol Wax) was applied from the melt to a desired surface. After cooling, a contact angle of water on the wax layer of 115° was found.

### COMPARATIVE EXAMPLE 7

A silicone oil with a viscosity of 200 mm²/s at 25° C. (Dow Corning 200 ex. Dow Corning) was applied uniformly to a desired surface. The contact angle of water on the treated surface was determined to be 91°.

It is clear from the tests that dioctadecyl ether according to examples 1 and 2 affords considerable advantages in terms of water repulsion compared to 1-octadecanol (comparative example 2), octadecane (comparative example 3) and waxes such as beeswax (comparative example 1), montan wax (comparative example 4) and paraffin wax (comparative example 5). A much better performance than with silicone oils (comparative example 7) was also found. To summarise, the examples clearly show that dialkyl ethers exhibit specific water-repelling properties, both as a pure substance and with use of additives (example 9).

TABLE 1

| | | Contact | |
|---|---|---|---|
| Product | Family | angle [°] | Pearlescent |
| Example 1 | Ether | 148 | yes |
| Example 2 | Ether | 148 | yes |
| Example 3 | Ether | 141 | yes |
| Example 4 | Ether | 141 | yes |
| Example 5 | Ether | 144 | yes |
| Example 6 | Ether | 144 | yes |
| Example 7 | Ether | 156 | yes |
| Example 8 | 80% ether/20% 1- | 153/170 | yes |
| | alkanol | | |
| Example 9 | 50% ether/50% 1- | 120 | yes |
| | alkanol | | |
| Comparative example 1 | Natural wax | 109 | no |
| Comparative example 2 | Long-chain 1-alkanol | 101 | no |
| Comparative example 3 | Long-chain 1-alkanol | 112 | no |
| Comparative example 4 | Long-chain paraffin | 115 | yes |
| Comparative example 5 | Montan wax | 106 | no |
| Comparative example 6 | Paraffin wax | 115 | no |
| Comparative example 7 | Silicone oil | 91 | no |

The easy removability of the material is demonstrated by the following examples:

### EXAMPLE 11

The contact angle of water on a glass slide was determined to be 11°. This slide was then coated with the melt comprising dioctadecyl ether. The contact angle of the surface was now 148°. Some of the coating was removed mechanically, and here the contact angle of water against the surface was measured. It was 12°. Another part of the coating was treated with a 60° C. 10% commercially available flushing agent solution (Palmolive®, Colgate GmbH) in water and the surface was rinsed off with deionised water. A new measurement of the contact angle of water against the surface also yielded a result of 12°.

### COMPARATIVE EXAMPLE 8

The contact angle of water on a glass slide was determined to be 11°. This slide was then treated with a silicone oil (Dow Corning 200). The contact angle of the water drop against the surface was measured to be 91°. The silicone oil was removed mechanically by means of wiping. Water had a contact angle of 56° on the surface thus cleaned. After this, the slide was treated with a 10% commercially available flushing agent solution (Palmolive®, Colgate GmbH) in water at 60° C. and the surface was rinsed off with deionised water. A new measurement gave a contact angle of 39°.

Example 11 and comparative example 8 show that it is possible to remove the coating according to the invention in a residue-free manner using suitable, for example mechanical or chemical measures. This is not possible for a coating with silicone oils without further hydrophobing of the surface.

The hydrophobing properties of the dialkyl ethers in combination with other long-chain compounds were examined with a further series of tests carried out in addition to examples 8 and 9. The mixture was applied to surfaces and, after cooling, the contact angle of water on a coated surface was determined.

It can be clearly seen that the optimum of the water-repelling properties is found with an 80:20 mixture of dioctadecyl ether and 1-octadecanol or stearic acid. The results are collated in Table 2.

TABLE 2

| | Dioctadecyl ether | 1-octadecanol | Contact angle |
|---|---|---|---|
| Example | [% by wt] | [% by wt] | [°] |
| A1 (=1) | 100 | 0 | 148 |
| A2 (=8) | 80 | 20 | 153/170 |
| A3 | 50 | 50 | 120 |
| A4 | 30 | 70 | 112 |
| A5 (=comp 2) | 0 | 100 | 101 |
| | Dioctadecyl ether | Stearic acid | Contact angle |
| Example | [% by wt] | [% by wt] | [°] |
| A6 | 100 | 0 | 148 |
| A7 | 90 | 10 | 154 |
| A8 | 80 | 20 | 170 |
| A9 | 70 | 30 | 131 |
| A10 | 0 | 100 | 137 |

An emulsion was subsequently produced. For this purpose 1.7% by weight of a mixture of Marlinat® 242/90M (mono-isopropanol ammonium salt of a linear C12-C14 alcohol polyethylene glycol ether (2 EO) sulphates), 0.7% by weight of a cetearyl ethoxylate (25 EO) and 3.5% by weight of demineralised water were combined and heated to 65° C. For this purpose a mixture of 35.3% by weight was added to the dioctadecyl ether mixture heated to 65° C. (for example 80:20 in accordance with Example A2). 58.8% by weight were then added to water heated to 65° C. and the emulsion was cooled slowly. The paste produced was used for the examples in Table 3. The surface forms a slide coated with a car paint. The contact angle of water on the surface was determined before and after polishing with a hydrophobing paste and in comparison to commercial car polishes.

A considerable improvement in performance can be seen with use of the wax paste described in Example A12.

The commercial polishes of comparative examples A1-A4 already contain abrasive bodies. Even without abrasive bodies, the polish from Example A12 yields better results. The result could be improved further still with an addition of 3% abrasive bodies (in this case Aerosil 300) (see Example A12).

TABLE 3

| | | Contact | Increase in water |
|---|---|---|---|
| Example | Active component | angle [°] | repulsion [°] |
| A11 | none | 88 | — |
| A2 | Example A2 | 115 | 27 |
| A4 | Example A4 | 96 | 8 |
| A12 | Example A2 + 3% | 127 | 39 |
| | abrasive paste (Aerosil | | |
| | 300) | | |
| Comp. ex. A1 | Nigrin hard wax | 101 | 13 |
| Comp. ex. A2 | Nigrin paint protection | 106 | 18 |
| Comp. ex. A3 | Nigrin cleaning polish | 106 | 18 |
| Comp. ex. A4 | W5 car care | 98 | 10 |

In order to assess the oil-repelling properties, the contact angle of white oil Merkur WOP 100 WB on the surface was determined on the coated surfaces in accordance with the aforementioned examples. At the same time, the etching of the coating and the spreading of the oil drop were assessed after 1 h and after 24 h.

TABLE 4

| | | Etching of the | | Spreading of the | |
|---|---|---|---|---|---|
| | Contact | coating after | | oil drop after | |
| Example | angle [°] | 1 h | 24 h | 1 h | 24 h |
| 1 | 68 | no | no | no | slight |
| 3 | 57 | no | no | slight | yes |
| 5 | 66 | no | no | no | slight |
| 8 | 63 | no | no | no | slight |
| Comp. ex. A1 | 41 | no | no | no | slight |
| Comp. ex. A2 | 52 | no | slight | yes | yes |
| Comp. ex. A4 | 40 | yes | yes | yes | yes |
| Comp. ex. A5 | 42 | no | no | no | slight |
| Comp. ex. A6 | 42 | no | no | no | slight |

It can clearly be seen that examples 1, 5 and 8 result in an improvement in oil repulsion, measured by the contact angle, and exhibit a comparative spreading behaviour after 1 h and 24 h.

In order to examine the adhesion to glass or metal, black steel and a glass surface were coated with the wax. A lattice design was scratched in using a special comb (similarly to DIN EN ISO 2409) and the adhesion was assessed visually.

It was found that the mixture from Example A8 was best suited for a coating of metal and that the mixture from Example 8 was best suited for the coating of glass.

1. A coating for a surface comprising mean layer thicknesses of 50 nm to 500 μm formed of a coating material, wherein the coating material
a) comprises 50% by weight of one or more dialkyl/dialkenyl ethers and the dialkyl/dialkenyl ethers have the general formula R¹—O—R², in which R¹ and R² each, independently of one another, stand for a substituent comprising any saturated alkyl radical or unsaturated alkenyl radical which together comprise more than 18 carbon atoms, and
the coating further comprises
b1) 5 to 40% by weight of at least one C14 to C36 alcohol and/or
b2) 5 to 40% by weight of at least one C14 to C36 carboxylic acid.

2. The coating according to claim 1, characterised in that the alkyl/alkenyl substituents of the dialkyl/dialkenyl ethers together comprise more than 21 carbon atoms.

3. The coating according to claim 1, characterised in that linear dialkyl/dialkenyl ethers comprise dialkyl ethers.

4. The coating according to claim 1, characterised in that the dialkyl ethers comprise ditetradecyl ethers, dihexadecyl ethers, dioctadecyl ethers, dieicosyl ethers, didocosyl ethers or materials thereof.

5. The coating according to claim 1, characterised in that the coating can be applied in the form of a solid, suspension, solvent, emulsion or melt.

6. The coating according to claim 1, characterised in that the coating has a pearlescent effect.

7. The coating according to claim 1, characterised in that the contact angle of water on the coated surface is greater than 130°.

8. The coating according to claim 1, characterised in that the dialkyl/dialkenyl ethers have a solidification point, measured in accordance with DIN 53175 of 40 to 100° C.

9. The coating according to claim 1, characterised in that the coating can cover a temporary coating or surface that can be removed using surfactant-containing aqueous cleaning agents.

10. (canceled)

11. The coating according to claim 1, characterised in that the coating contains 7 to 30% by weight of said C14 to C36 alcohols.

12. (canceled)

13. The coating according to claim 1, characterised in that the coating contains 7 to 30% by weight of carboxylic acids.

14. The coating according to claim 1, characterised in that the coating further contains 0.5 to 10% by weight of inorganic particles having mean particle diameters D₅₀ of less than 50 μm, determined in accordance with ISO 13320-1 and evaluated in accordance with the Fraunhofer theory.

15-18. (canceled)

19. A method of coating a substrate with a coating having a mean layer thickness of 50 nm to 500 μm comprising:
applying to said substrate the coating material of claim 1.

20. The method of claim 19, wherein said substrate comprises leather, uncoated metals or painted surfaces.
